(19) United States
(12) Patent Application Publication
(10) Pub. No.: US 2014/0266070 A1
(43) Pub. Date: Sep. 18, 2014

(54) Apparatus and Method for Enhancing Battery Life

(71) Applicant: Zvi Kurtzman, Sandy Springs, GA (US)

(72) Inventor: Zvi Kurtzman, Sandy Springs, GA (US)

(21) Appl. No.: 13/831,173

(22) Filed: Mar. 14, 2013

(51) Int. Cl. H02J 7/00

(52) U.S. Cl. CPC H02J 7/0052
USPC 320/149

(57) ABSTRACT

An apparatus and method for enhancing battery life including monitoring a first voltage level of a battery; receiving a first indication of the first voltage level; comparing the first indication to a first threshold to derive a comparison; determining if the battery needs charging based on the comparison; and configuring at least one switching mechanism to engage at least one capacitor to charge the battery.

### FIELD

This disclosure relates generally to apparatus and methods for enhancing battery life. More particularly, the disclosure relates to using electrical storage for enhancing battery life.

### BACKGROUND

Currently, almost everyone relies on an electronic device that uses batteries as its energy source. Mobile phones, electronic screens or pads, portable computers, cameras, video and/or audio recorders, etc. are just a few of the mobile electronic devices that rely on batteries to operate while their users are in transit. Even when the users are stationary, for example, working at a desk or relaxing at home, these mobile electronic devices are not usually plugged into a power jack unless there are indications that the batteries are low and recharging is necessary. In a society of mobile electronic devices with users in transit, it is desirable to prolong the life of the batteries that power the mobile electronic devices.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Disclosed is an apparatus and method for enhancing battery life. According to one aspect, method for enhancing battery life including monitoring a first voltage level of a battery; receiving a first indication of the first voltage level; comparing the first indication to a first threshold to derive a comparison; determining if the battery needs charging based on the comparison; and configuring at least one switching mechanism to engage at least one capacitor to charge the battery.

According to another aspect, a device for enhancing battery life including a capacitor bank comprising of at least one capacitor; a processor for performing the following: a) monitoring a first voltage level of a battery, b) receiving a first indication of the first voltage level, c) comparing the first indication to a first threshold to derive a comparison, and d) determining if the battery needs charging based on the comparison; and a switch control for configuring at least one switching mechanism to engage one or more of the at least one capacitor to charge the battery.

Advantages of the present disclosure may include longer battery operating time between required charge ups at a stationary power jack and longer battery life

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

FIG. 1 illustrates an example of a battery recharging system.

FIG. 2 illustrates an example flow diagram for enhancing battery life.

FIG. 3 illustrates an example of a device including a processor in communication with a memory for enhancing battery life.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the present disclosure.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

FIG. 1 illustrates an example of a battery recharging system 100. The battery recharging system 100 includes a battery 110 (a.k.a., battery unit), a capacitor bank 130, a processor 150 and switch control 170. In one example, the switch control 170 is a component of the processor 150. The battery 110 is the voltage source for a load 180. In one example, the battery 110 (a.k.a., battery unit) includes more than one batteries. In one example, the load 180 is a mobile electronic device, such as but not limited to, a mobile phone, an electronic screen or pad, a portable computer, a camera, video and/or audio recorders, etc. One skilled in the art would understand that the examples of the load disclosed herein are not limiting and not exclusive. Other types of loads are within the scope and spirit of the present disclosure.

The battery 110 provides voltage output to the load 180. The load 180 may include one or more of the following: mobile phones, electronic screens or pads, portable computers, cameras, video and/or audio recorders, etc. In one application, the battery 110 provides low power for such devices as those listed. However, in another application, the battery 110 provides high power (or higher power) for such devices as a car battery, etc. One skilled in the art would understand that the listed presented herein of the load 180 is not exclusive and that other electronic device may be included without affecting the scope and spirit of the present disclosure. In one aspect, the battery 110 is a rechargeable battery.

As shown in FIG. 1, the battery 110 includes a positive terminal 112 and a negative terminal 113. The capacitor bank 130 includes a plurality of capacitors 132, a plurality of switches 134 and a first terminal 136 and a second terminal 137. As shown in the example of FIG. 1, the first terminal 136 of the capacitor bank 130 is coupled to the positive terminal 112, and the second terminal 137 of the capacitor bank 130 is coupled to the negative terminal 113. Capacitor charging of the battery is achieved through the connections of their respective terminals.

In one example, the capacitor bank 130 may include one or more of the following types of capacitors: ceramic capacitors, electrolytic capacitors, tantalum capacitors, film capacitors (including plastic film capacitors, film dielectric capacitors, or polymer film capacitors), electrochemical capacitors (such as super capacitors, electrical double-layer capacitors (EDLC), or pseudocapacitors), silver mica capacitors and/or vacuum capacitors, etc. Additionally, the capacitors may be of the type known as SUP Cap, ULTRA Cap, and/or carbon fiber capacitors. One skilled in the art would understand that other types of capacitors not listed herein may also be used in the present disclosure without affecting the scope and spirit of the present disclosure.

A monitor channel 140 couples the battery 110 and the processor 150. In one example, the processor 150 uses the monitor channel 140 to monitor the status of the battery 110. In one example, the monitor channel 140 communicates information about the status of the battery 110 to the processor 150. For example, the monitor channel 140 communicates the voltage level of the battery 110 to the processor 150. In one example, the monitor channel 140 is an electrical line that connects the battery 110 to the processor 150. In another example, the monitor channel 140 is a wireless channel that couples the battery 110 and the processor 140.

The processor 150 is coupled to the switch control 170 through a control channel 160. In one example, the control channel 160 is an electrical line that connects the processor 150 and the switch control 170. In another example, the control channel 160 is a wireless channel that couples the processor 150 and the switch control 170.

The switch control 170 is coupled to the switches 134 through switch control channels 174. In one example, the switch control channel 174 is at least one electrical line that connects the switch control 170 to the switches 134. In another example, switch control channel 174 is a wireless channel that couples the switch control 170 to the switches 134 to configure the switches 134.

In one example, the processor 150 monitors the voltage level of the battery 110. In one example, the monitor channel 140 is used for the monitoring. Information of the battery's voltage level is communicated to the processor 150, for example, through the monitor channel 140. The battery's voltage level status may be reported periodically or continuously. In one example, the processor 150 compares the battery's voltage level to a threshold. If the voltage level is less than the threshold, the processor 150 sends a signal through the control channel 160 to the switch control 170 to engage at least one capacitor 132 to charge the battery 110. The value of the threshold may be a fixed value based on a variety of factors, such as but not limited to, type of load, power consumption of load, user choice, design choice, application and/or usage, etc.

In one example, the processor 150 compares the battery's voltage level to a plurality of thresholds and the content of the signal sent by the processor 150 to the switch control 170 will depend on which ones of the thresholds is less than that of the battery's voltage level. For example, if the battery's voltage level is less than a particular threshold, the processor 150 may instruct the switch control 170 to engage one or multiple quantities of capacitors 132 to charge the battery 110.

In one example, the multiple quantities of capacitors 132 are connected to the battery 110 to perform simultaneous charging of the battery 110. In another example, the multiple quantities of capacitors 132 are connected one at a time in a fixed or a predetermined timing sequence to the battery 110 to perform sequential charging of the battery 110. In one example, even after the battery is being charged, monitoring of the battery's voltage level continues. In one example, the processor receives a second voltage level indication and compares the second voltage level indication to a second threshold to determine the status of charging of the battery. The second threshold value may or may not be the same as the previous threshold value. If the comparison of the second voltage level indication and the second threshold indicates that charging of the battery is sufficient, the processor 150 sends a second signal to reconfigure the at least one switching mechanism to disengage the at least one capacitor from charging the battery. In one example, the processor 150 instructs the switch control 170 to send a second signal to reconfigure the at least one switching mechanism to disengage the at least one capacitor from charging the battery.

In one example, the quantity of capacitors is divided into multiple sets of capacitors. In this example, one set of capacitors is used to charge the battery 110 while another set of capacitors may be being recharged or is not used at all. In one example, the number of capacitors in a set of the multiple sets of capacitors is variable. For example, given a capacitor bank 130 with a fixed quantity of capacitors, a user may chose X number of capacitors to be in a first set and Y number of capacitors to be in a second set and Z number of capacitors to be in a third set, such that the sum of X, Y and Z equals the total quantity of capacitors in the capacitor bank 130.

However, even after the number of capacitors in a particular set is chosen, the user may then vary the number of capacitors in each of the sets. For example, the user may now chose A number of capacitors to be in the first set and B number of capacitors to be in the second set and C number of capacitors to be in the third set. Again, the sum of A, B and C equals the total quantity of capacitors in the capacitor bank 130, but A may not equal X, B may not equal Y and C may not equal Z. In yet another variation, the user may increase or decrease the quantity of sets, for example, choosing four sets instead of just having the three sets. Or, the user may change the four sets to two sets, etc. One skilled in the art would understand that there are many possibilities of the quantity of sets. And, there are many possibilities of the quantity of capacitors in each set.

One implementation of achieving a variable quantity of capacitors in a set or achieving variable sets of capacitors in a capacitor bank is the use of switching mechanisms. In one example, the switching mechanisms are mechanical switches that can be manually configured or by a relay. In another example, the switching mechanisms are configured electronically and/or by a software program. In one aspect, a software program may be used to control the switching mechanisms, that is, to vary the quantities of capacitors in a set. In one aspect, a software program may be used to control the switching mechanisms to vary the quantity of sets in a capacitor bank. In one example, the quantity of capacitors in a set may be based on the type of load and/or the real time load power consumption. In one example, the quantity of sets may be based on the type of load and/or the real time load power consumption.

FIG. 2 illustrates an example flow diagram 200 for enhancing battery life. In block 210, monitor a first voltage level of a battery. In block 220, receive an indication of the first voltage level. In block 230, compare the indication of the first voltage level to a first threshold to derive a comparison. In block 240, determine if the battery needs charging based on the comparison. In block 250, send a signal to configure at least one capacitor to charge the battery. In block 260, configure at least one switching mechanism to engage the at least one capacitor to charge the battery. In block 270, receive a second indication of a second voltage level and compare the second indication of the second voltage level to a second threshold to determine a status of charging the battery. In block 280, send a second signal to reconfigure the at least one switching mechanism to disengage the at least one capacitor from charging the battery.

In one example, the at least one capacitor is a set of variable quantities of capacitors. In one example, the at least one capacitor is a capacitor bank with at least two sets of variable quantities of capacitors. In one example, while one of the at least two sets of variable quantities of capacitors is engaged with the battery for charging the battery, another of the at least two sets of variable quantities of capacitors is being recharged, for example, by plugging into a power grid. In one example, the configurations of the switching mechanisms coupled to the at least one capacitor are used for varying the quantities of capacitors in each set and/or the quantities of sets in the capacitor bank.

One skilled in the art would understand that the steps disclosed in the example flow diagram in FIG. 2 can be interchanged in their order without departing from the scope and spirit of the present disclosure. Also, one skilled in the art would understand that the steps illustrated in the flow diagram are not exclusive and other steps may be included or one or more of the steps in the example flow diagram may be deleted without affecting the scope and spirit of the present disclosure.

Those of skill would further appreciate that the various illustrative components, logical blocks, modules, circuits, and/or algorithm steps described in connection with the examples disclosed herein may be implemented as electronic hardware, firmware, computer software, or combinations thereof. To clearly illustrate this interchangeability of hardware, firmware and software, various illustrative components, blocks, modules, circuits, and/or algorithm steps have been described above generally in terms of their functionality. Whether such functionality is implemented as hardware, firmware or software depends upon the particular application and design constraints imposed on the overall system. Skilled artisans may implement the described functionality in varying ways for each particular application, but such implementation decisions should not be interpreted as causing a departure from the scope or spirit of the present disclosure.

For example, for a hardware implementation, the processing units (such as the processor) may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described therein, or a combination thereof. With software, the implementation may be through modules (e.g., procedures, functions, etc.) that perform the functions described therein. The software codes may be stored in memory units and executed by a processor unit. Additionally, the various illustrative flow diagrams, logical blocks, modules and/or algorithm steps described herein may also be coded as computer-readable instructions carried on any computer-readable medium known in the art or implemented in any computer program product known in the art. In one aspect, the computer-readable medium includes non-transitory computer-readable medium.

In one or more examples, the steps or functions described herein may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In one example, the illustrative components, flow diagrams, logical blocks, modules and/or algorithm steps described herein are implemented or performed with one or more processors. In one aspect, a processor is coupled with a memory which stores data, metadata, program instructions, etc. to be executed by the processor for implementing or performing the various flow diagrams, logical blocks and/or modules described herein. FIG. 3 illustrates an example of a device 300 including a processor 310 in communication with a memory 320 for enhancing battery life. In one example, the device 300 is used to implement the algorithm illustrated in FIG. 2. In one aspect, the memory 320 is located within the processor 310. In another aspect, the memory 320 is external to the processor 310. In one aspect, the processor includes circuitry for implementing or performing the various flow diagrams, logical blocks and/or modules described herein.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

1. A method for enhancing battery life, comprising:
monitoring a first voltage level of a battery;
receiving a first indication of the first voltage level;
comparing the first indication to a first threshold to derive a comparison;
determining if the battery needs charging based on the comparison; and
configuring at least one switching mechanism to engage at least one capacitor to charge the battery.

2. The method of claim 1, further comprising sending a signal to configure the at least one capacitor to charge the battery.

3. The method of claim 1, further comprising receiving a second indication of a second voltage level and comparing the second indication to a second threshold to determine a status of charging the battery.

4. The method of claim 3, further comprising disengaging the at least one capacitor from charging the battery.

5. The method of claim 4, further comprising sending a second signal to reconfigure the at least one switching mechanism to disengage the at least one capacitor from charging the battery.

6. The method of claim 1, wherein the at least one capacitor comprises a set of variable quantities of capacitors.

7. The method of claim 6, further comprising varying the configurations of the at least one switching mechanism to vary the variable quantities of capacitors in the set.

8. The method of claim 1, wherein the at least one capacitor is a capacitor bank, and wherein the capacitor bank comprises a variable quantity of sets of capacitors.

9. The method of claim 8, further comprising varying the configurations of the at least one switching mechanism to vary the variable quantity of sets of capacitors.

10. The method of claim 9, wherein one of the variable quantity of sets of capacitors is engaged to charge the battery and another of the variable quantity of sets of capacitors is plugged into a power grid for recharging.

11. A device for enhancing battery life comprising:
a capacitor bank comprising of at least one capacitor;
a processor for performing the following:
a) monitoring a first voltage level of a battery;
b) receiving a first indication of the first voltage level;
c) comparing the first indication to a first threshold to derive a comparison; and
d) determining if the battery needs charging based on the comparison; and
a switch control for configuring at least one switching mechanism to engage one or more of the at least one capacitor to charge the battery.

12. The device of claim 11, further comprising a switch control channel, wherein the switch control is further configured for sending a signal through the switch control channel to configure the one or more of the at least one capacitor to engage or disengage.

13. The device of claim 11, further comprising a monitor channel for communicating a second indication of a second voltage level to the processor, and wherein the processor is further configured for comparing the second indication to a second threshold to determine a status of charging the battery.

14. The device of claim 13, wherein the switch control if further configured to disengage the at least one capacitor from charging the battery.

15. The device of claim 14, wherein the switch control sends a second signal to reconfigure the at least one switching mechanism to disengage the at least one capacitor from charging the battery.

16. The device of claim 11, wherein the at least one capacitor comprises a set of variable quantities of capacitors.

17. The device of claim 16, wherein the switch control is further configured for varying the configurations of the at least one switching mechanism to vary the variable quantities of capacitors in the set.

18. The device of claim 11, wherein the at least one capacitor is a capacitor bank, and wherein the capacitor bank comprises a variable quantity of sets of capacitors.

19. The device of claim 18, the switch control is further configured for varying the configurations of the at least one switching mechanism to vary the variable quantity of sets of capacitors.

20. The device of claim 19, wherein one of the variable quantity of sets of capacitors is engaged to charge the battery and another of the variable quantity of sets of capacitors is plugged into a power grid for recharging.

21. The device of claim 11, wherein the switch control is a component of the processor.
